(19) United States
(12) Patent Application Publication
(10) Pub. No.: US 2013/0060177 A1
(43) Pub. Date: Mar. 7, 2013

(54) MASSAGE APPARATUS FOR USE IN A VAGINAL OR RECTAL CAVITY OR A VAGINAL OR RECTAL OPENING OF THE HUMAN BODY

(71) Applicant: Bianca Künnecke, Hannover (DE)

(72) Inventor: Bianca Künnecke, Hannover (DE)

(73) Assignee: Redschlag Holding GmbH, Hannover (DE)

(21) Appl. No.: 13/605,160

(22) Filed: Sep. 6, 2012

(30) Foreign Application Priority Data
Sep. 6, 2011 (DE) 10 2011 112 355.9

(51) Int. Cl. A61H 7/00

(52) U.S. Cl. 601/137

(57) ABSTRACT

An insertion apparatus for use in a vaginal or rectal cavity or a vaginal or rectal opening of the human body. The insertion apparatus has a base body, which in turn has a working body. In addition, a pulling device used for removing the working body from the cavity or the opening is firmly mounted on the base body. The pulling device is formed by a finger grip that is elastically formed, at least in part. The finger grip is elastically deformable between a neutral position and a removal position, and the finger grip is made, at least in part, of an elastic material. The insertion apparatus may in particular be configured as a massage apparatus or as a tampon.

### FIELD OF THE INVENTION

The invention relates to insertion apparatuses, configured as massage apparatuses, for use in a vaginal or rectal cavity or a vaginal or rectal opening of the human body.

### BACKGROUND OF THE INVENTION

Massage apparatuses of the stated type are used for massage or training of the above-mentioned areas of the human body.

These types of massage apparatuses may have different constructions, shapes, structures, and designs.

Massage apparatuses of the type in question may be designed in various ways, in particular as designs which are modular, integral, one-piece, and which also may be disassembled.

In addition, a power source such as an accumulator or a battery may be provided for the massage apparatuses in question to allow a function or action to be produced or intensified using this power source. Thus, by means of a power source and an appropriate power converter, heat may be generated to assist in massage, for example.

On the other hand, massage apparatuses of the type in question are designed in particular in such a way that no additional power must be supplied to the massage apparatus in question, so that the massage apparatus may be used in particular in a current-free manner.

Massage apparatuses of the type in question may be inserted or applied, at least in part, in a vaginal or rectal cavity or a vaginal or rectal opening of the human body, for example, and assume a use position in which they carry out one or more primary or secondary functions.

These types of massage apparatuses may act on at least one section of the corresponding cavity or opening of the human body in order to massage or train in particular a muscle or a muscle part.

### DESCRIPTION OF THE PRIOR ART

The known massage apparatuses are provided for use in a vaginal or rectal cavity or a vaginal or rectal opening of the human body, having a base body which has at least one massage element and a pulling device, firmly mounted on the base body, for removing the massage element from the vaginal or rectal cavity or the vaginal or rectal opening.

The known massage apparatuses are removed from a vaginal or rectal cavity or a vaginal or rectal opening of the human body with the aid of a pulling device which is often designed as a thread or band made of Nylon, among other materials, and which, in particular forming a loop, is firmly mounted on the massage apparatus or the massage element thereof. The pulling device may also have a ring-shaped design. In some cases an elastic material is used which forms or coats the pulling device at least in places, thus allowing, among other things, better and simpler cleaning of the pulling device. If the pulling device contains an elastic material, due to the material properties, when a tensile force is applied this material elongates in proportion to this tensile force in the affected area.

Known insertion apparatuses for use in a cavity or an opening of the human body, have, among other things, a pulling device which has a finger grip that is elastically formed, at least in places, and which is elastically deformable between a neutral position and a removal position. The finger grip is made in part of elastic material to allow the elastic formability. These types of insertion apparatuses are known from EP 1 338 886 A1, for example, whereby a sampling system is known which has an opening closure that is elastically deformable.

In addition, an insertion apparatus in the form of a tampon is known from DE 69 80 7196 T2, having a cord as pulling device and a finger grip made of plastic which is elastically held on the tampon via a bellows apparatus.

DE 10 2008 034 730 A1 likewise discloses an insertion apparatus designed as a tampon, having a pulling device designed as a cord for removing the tampon from the body opening, this pulling device being connected to a spring, bent from wire, which is elastically deformable via the pulling device under tensile stress.

Furthermore, a massage apparatus is known from U.S. Pat. No. 7,104,950 B2 for use in a cavity or an opening of the human body, having a pulling device, firmly mounted on the massage element, for removing the massage element from the cavity or the opening of the human body, the pulling device having a flexible section via which a liquid contained in the massage element may preferentially be acted on by a pressure by deformation of this section. Via this type of pulling device, a finger grip is formed which is elastically deformable between a neutral position and a removal position. The finger grip is made, at least in part, of an elastic material.

Known massage apparatuses have the disadvantage that, in particular in a design of the pulling device as a thread or band, an undesired displacement occurs, in that the pulling device is inadvertently acted on by a tensile force. This may result, among other things, from the pulling device being caught, for example, at a location and a tensile force being generated by a motion relative to the massage apparatus which causes a corresponding displacement of the massage apparatus.

### OBJECTS AND SUMMARY OF THE INVENTION

An object of the invention is to provide a massage apparatus which prevents the disadvantages of the known insertion apparatuses designed as massage apparatuses, and in particular provides better handling.

This object is achieved by the invention set forth herein.

The invention departs from the concept of providing a massage apparatus according to the previously implemented designs. Rather, the invention is based on the concept of reducing the dimensions of the massage apparatus, in particular in the use position of the massage apparatus, and improving the handling of the massage apparatus.

Thus, an object is achieved according to the invention in that the finger grip has at least one spring section, the spring section having an elongation region in which its shape elasticity is greater than its material elasticity. This results in the advantage of dividing the finger grip into different sections which are optimized for meeting the functions of the finger grip. Thus, one spring section according to the invention is configured for optimizing the spring function, while other sections of the finger grip may be configured in particular from an ergonomic standpoint. The spring section may, for example, be made of an elastic material or contain the same, at least in part, thus increasing elastic deformability of the finger grip.

A further advantage is that the deformability of the spring section is greatly increased as a result of the structural configuration. The elastic configuration of the spring section thus contributes significantly to the flexible deformation of the finger grip when a tensile force is applied to the finger grip.

This results in the advantage that the pulling device in the unstressed state has extremely small dimensions, thus also reducing the overall dimensions of the massage apparatus, in particular in the use position thereof.

According to the invention, the finger grip is activated using at least one finger of the human hand. In addition, according to the invention the finger grip is also preferably activatable using two fingers of the human hand, in particular the thumb and index finger or middle finger.

According to the invention, a use position of a massage apparatus according to the invention is understood to mean reaching a position or a location in a vaginal or rectal cavity or a vaginal or rectal opening of the human body in which the massage element is able to act so as to achieve its function. The massage element acts in particular on a portion of the wall of the cavity or a portion of the opening in order to achieve the desired function or action (i.e., working) of the massage apparatus.

For clarity in the description, the term “function” is always used below in the singular, although the plural of this term is also encompassed.

The resulting advantage is that in the use position of a massage apparatus according to the invention, the massage apparatus is completely accommodated in particular in the cavity of the human body due to the greatly reduced dimensions of the pulling device as compared to known massage apparatuses. The formation of a channel to the external environment of the cavity or the opening as the result of guiding the pulling device is thus prevented. Thus, for example, bacteria are effectively prevented from entering the opening of the human body via the pulling device, which could contribute to disease.

According to the invention, a vaginal or rectal cavity or a vaginal or rectal opening of the human body is characterized in that the respective cavity or opening in each case may be at least temporarily closed by means of at least one muscle.

In addition, according to the invention one or more massage elements may be used. When multiple massage elements are used, these may have shapes that are the same or different from one another, and may also have differences in at least one geometric dimension. Thus, for example, the outer contours of the particular massage elements may have the same shape but different dimensions. Furthermore, when multiple massage elements are used, they may be situated at a distance from or adjacent to one another.

According to the invention, a finger grip is understood in particular to mean an apparatus which is used to enable the massage apparatus to be applied to, in particular removed from, a vaginal or rectal cavity or a vaginal or rectal opening of the human body, whereby the finger grip may be gripped using at least one finger of the human hand. According to the invention, a finger grip is in particular a preformed body whose shape implements an elastic action. When a tensile stress is applied to a finger grip according to the invention, the finger grip is able to elastically deform, in particular due to its elastic shape, causing it to elongate, in particular in the pulling direction, under a tensile stress. Due to the elastic shape, the finger grip returns to its original shape after tension is relieved.

The finger grip is thus elastically deformable between a neutral position in which the finger grip is relieved, in particular relieved of tension, and a removal position in which a finger grip according to the invention is acted on by a load, in particular a tensile force. The elastic deformability of the finger grip according to the invention is assisted in that the finger grip is made, at least in part, of an elastic material.

The elastic deformability is increased as a result of the combination of an elastic shape and the use of an elastic material, thus likewise preventing the finger grip from breaking, for example due to occurrence of in particular unacceptably high tensile forces or mechanical component stresses.

Using a finger grip according to the invention results in the advantage that the finger grip not only allows removal from the body areas in question, but also results in better handling during insertion into, or application to, the mentioned areas.

The elastic shaping of the finger grip may be achieved using a variety of shapes. For this purpose, the finger grip may, for example, have one region with an elastic shape, while another region of the finger grip, for example, is configured in particular for ergonomics of the grip.

According to the invention, a finger grip according to the invention may have one or more spring sections which in particular are situated at a distance from one another on the finger grip. In addition, it is possible to use multiple spring sections having different configurations on a finger grip according to the invention.

According to one advantageous further embodiment of the invention, the finger grip has at least one grip section. This results in the advantage that the ergonomics of the finger grip are increased, in that a corresponding section is provided which is optimized in particular with regard to its shape for meeting the gripping function. Gripping the finger grip, in particular in the use position of the massage apparatus, is thus improved.

The grip section may be configured in various ways. For example, the surface of the grip section may be configured to have the best possible grip, in particular as the result of a rough surface or by using a nubbed structure.

To improve the grip, the grip section may have an eyelet-like shape, at least in places, as taken into account by another advantageous further embodiment of the invention. In particular a finger, preferably the index finger, of the human hand may engage in the eyelet and thus easily apply a tensile force to the finger grip. In addition, with regard to its deformation properties the grip section may have a rigid configuration to provide better introduction of a tensile force.

To optimize the length of the finger grip in the unstressed state, the grip section may partially, or also completely, overlap the spring section, in particular in a congruent manner. Thus, another advantageous further embodiment of the invention includes that the grip section overlaps the finger section, at least in places. The resulting advantage is that, in addition to a compact configuration, gripping over the entire outer surface of the finger grip may be optimized, thus dispensing with selective gripping of a certain section of the finger grip.

Another advantageous further embodiment of the invention is provided in that in a longitudinal cross section the finger grip is shaped like a hook, at least in places, at least one hook opening being directed toward the base body.

According to the invention, a longitudinal cross section of the cross section is understood to mean the section that is obtained in the direction of the extension of the finger grip away from the body (also referred to below as “longitudinal direction”). The direction of extension is in particular directed parallel to the pulling direction of the finger grip.

According to the invention, a hook may be formed in various ways and in different directions. Thus, for example, in a first embodiment the shape of the hook is formed in a side view, while in another embodiment the shape of the hook is formed in a top view of the massage apparatus, which otherwise has the same configuration as the first embodiment.

The hook shape may be configured, for example, as a simple hook having a hook opening, and also as an S-shaped hook.

When a hook shape having only one hook opening is used, this hook opening is preferably directed toward the base body. This results in the advantage that the free end of the finger grip may be gripped from behind by at least one finger of the human hand in order to extend the finger grip and thus be able to grip with assistance from the thumb, for example.

To enhance the ergonomics, in its profile cross section which results transverse to the longitudinal cross section the hook or the finger grip may have a recess which in particular extends from the geometric longitudinal center of the finger grip or hook to an edge region of the hook or of the finger grip. This results in the advantage that the finger grip may be activated using only one finger to allow a tensile force to be applied.

The finger grip is firmly mounted on the massage element, in particular molded onto same. For this purpose it is possible, among other things, to provide the massage element, at least in places, with a coating, for example made of a silicone or rubber material, from which a finger grip may be formed using the same material, for example. In addition, the finger grip may be mounted on the massage element in some other way, in particular molded on in one piece. Likewise, the finger grip may be adhesively bonded to the massage element or mounted on the massage element in some other force-fit, positive-fit, or integrally joined manner.

However, a holding element may also be provided to hold the massage element. This results in the advantage that the massage element is optimized with regard to its function(s), while the holding element may be used for additional functions, and thus configured in a correspondingly optimized manner. The particular material selection may also be made in various ways. Furthermore, manufacturing advantages result, in that one configuration of a massage element may be used in a variety of massage apparatuses.

To this end, another advantageous further embodiment of the invention provides that the base body has at least one holding element on which the massage element is held.

The massage element may be held on the holding element in various ways. Thus, the holding element may be adhesively bonded to the massage element or mounted in some other force-fit, positive-fit, or integrally joined manner. Furthermore, the holding element may be configured in such a way that it surrounds, in particular borders, the massage element in the peripheral direction of the massage element, at least in places, in particular in a ring-like manner, as provided in another advantageous further embodiment of the invention. This results in the advantage that the weight portion of the holding element relative to the massage apparatus may be minimized. The manufacturing and material costs may likewise be reduced.

When a holding element is used, it is possible for the finger grip to be mounted on the massage element, in particular molded on, preferably molded on in one piece. Likewise, as previously stated, the finger grip may be adhesively bonded to the massage element or mounted on the massage element in some other force-fit, positive-fit, or integrally joined manner.

It is also possible for the finger grip to be mounted on the holding element, in particular molded on, preferably molded on in one piece, as provided by another advantageous further embodiment of the invention. This results in the advantage that the manufacture of the holding element and of the finger grip may be carried out separately from the manufacture of the massage element. Furthermore, it is possible to use various massage elements with the holding element, thus increasing the flexibility of use of the holding element and the massage apparatus.

In addition, when multiple massage elements are used, these may be spaced apart at a distance with the aid of the holding element.

Another advantageous further embodiment of the invention provides that the base body has an integral or one-piece configuration. This results in an advantage in the handling of a massage apparatus according to the invention, for example also with regard to logistical aspects. Furthermore, a one-piece embodiment of a massage apparatus according to the invention results in a manufacturing advantage, since the necessary manufacturing processes may be reduced.

For hygienic reasons, cleaning should be as simple as possible. In this regard, another advantageous further embodiment of the invention provides that the base body has a coating, at least in places. This coating may also be used to support or supplement the function(s) of the massage element. A massage function, for example, may be enhanced in this way. It is also possible to form the finger grip from the coating.

On the other hand, it is also possible to coat the individual components of a massage apparatus according to the invention, at least in part, or to provide same with different coatings, or to leave same uncoated.

Furthermore, it is possible for the coating to have a surface structure in order to enhance the action of a massage element according to the invention.

A massage element according to the invention may be used for different purposes, and therefore may be configured in various ways.

According to the invention, massage is understood to mean mechanical influencing of skin, connective tissue, and musculature via stimulation by extension, traction, or compression. Accordingly, the invention, in addition to the above-mentioned purposes, also encompasses use of a massage apparatus for training muscles.

In particular, a massage apparatus according to the invention is used in the use position for massaging or training the pelvic floor musculature.

In addition to the above-mentioned functions, a massage apparatus according to the invention may be used to induce or produce human stimulation, in particular sexual stimulation. Among other things the finger grip, for example, may be used for this purpose.

The invention is explained in greater detail below with reference to the accompanying drawings which illustrate an embodiment of a massage apparatus according to the invention. All features claimed, described, and illustrated in the drawings constitute the subject matter of the invention, alone or in any given combination, independently of their combination in the claims or dependencies, and independently of their description or illustration in the drawings.

The figures of the drawing show possible embodiments of a massage apparatus according to the invention, in each case in a schematic illustration to which the invention is not limited. Therefore, the illustrations in particular are not to scale or detail, but rather, for a better overview are reduced to the elements which assist in understanding.

### BRIEF DESCRIPTION OF THE DRAWINGS

FIG. 1a shows a schematic side view of a first embodiment of a massage apparatus according to the invention;

FIG. 1b shows a top view of the massage apparatus according to the invention corresponding to FIG. 1a as seen in the direction of arrow A in FIG. 1a, in the same manner of illustration as in FIG. 1a;

FIG. 2a shows a second embodiment of a massage apparatus according to the invention in a schematic side view;

FIG. 2b shows a top view of the massage apparatus according to the invention corresponding to FIG. 2a as seen in the direction of arrow A in FIG. 2a, in the same manner of illustration as in FIG. 2a;

FIG. 3a shows a third embodiment of a massage apparatus according to the invention in a schematic side view;

FIG. 3b shows a top view of the massage apparatus according to the invention corresponding to FIG. 3a as seen in the direction of arrow A in FIG. 3a, in the same manner of illustration as in FIG. 3a;

FIG. 3c shows a top view of a fourth embodiment of the invention that may be understood as a modification of the third embodiment of a massage apparatus according to the invention corresponding to FIG. 3a, the fourth embodiment of a massage apparatus according to the invention is shown as seen in the direction of arrow A in FIG. 3a, in the same manner of illustration as in FIG. 3a;

FIG. 4a shows a fifth embodiment of a massage apparatus according to the invention in a schematic side view;

FIG. 4b shows a top view of the massage apparatus according to the invention corresponding to FIG. 4a as seen in the direction of arrow A in FIG. 4a, in the same manner of illustration as in FIG. 4a;

FIG. 5a shows a sixth embodiment of a massage apparatus according to the invention in a schematic side view;

FIG. 5b shows a top view of the massage apparatus according to the invention corresponding to FIG. 5a as seen in the direction of arrow A in FIG. 5a, in the same manner of illustration as in FIG. 5a;

FIG. 6a shows a seventh embodiment of a massage apparatus according to the invention in a schematic side view;

FIG. 6b shows a top view of the massage apparatus according to the invention corresponding to FIG. 6a as seen in the direction of arrow A in FIG. 6a, in the same manner of illustration as in FIG. 6a;

FIG. 7 shows an eighth embodiment of a massage apparatus according to the invention in a schematic side view;

FIG. 8 shows a schematic side view of a ninth embodiment of a massage apparatus according to the invention, analogous to the manner of illustration in FIG. 7; and

FIG. 9 shows a schematic side view of a tenth embodiment of a massage apparatus according to the invention, analogous to the manner of illustration in FIG. 7.

### DETAILED DESCRIPTION OF THE INVENTION

For better understanding, the illustrations in the figures are limited to the components of the illustrated embodiments which are essential for understanding. Identical or corresponding components/constituents or elements are provided with the same reference numerals in the figures.

The illustrations in the figures show embodiments of an insertion apparatus according to the invention in its configuration as a massage apparatus.

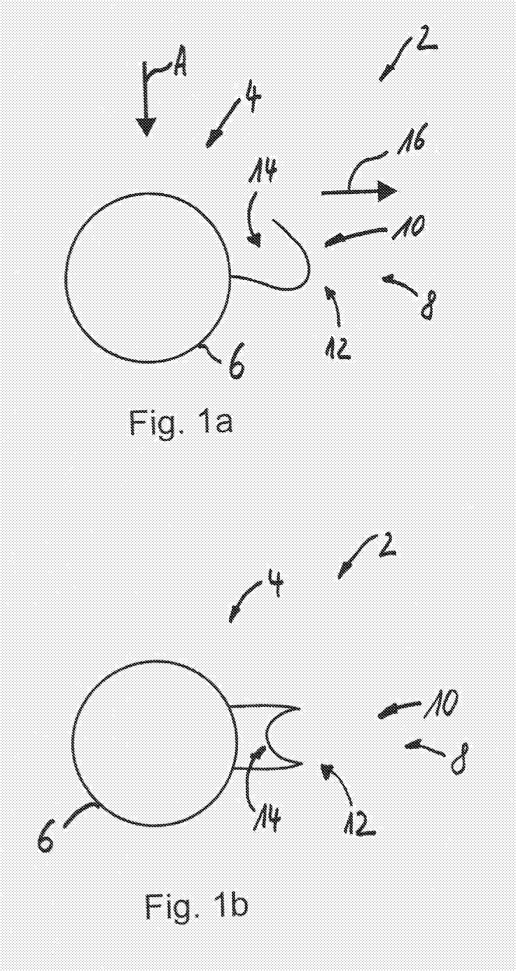

FIG. 1 shows a first embodiment of a massage apparatus 2 according to the invention in a schematic side view. According to the invention, a massage apparatus 2 according to the invention is used in a vaginal or rectal cavity or a corresponding opening, which for better clarity are not depicted.

The massage apparatus 2 formed according to the invention is provided with a base body 4, the base body 4 having at least one working body, namely active element or massage element 6, and a pulling device 8, firmly mounted on the base body 4, for removing the working body or massage element 6 from the cavity or the opening of the human body. In addition, the pulling device 8 of the massage element 2 according to the invention is configured as a finger grip 10 which is elastically formed, at least in places, the finger grip 10 being elastically deformable between a neutral position and a removal position. In addition, the finger grip 10 is made, at least in part, of an elastic material.

In this embodiment of a massage element 2 according to the invention, the finger grip 10 in a longitudinal cross section is shaped like a hook 12, at least in part, at least one hook opening 14 being directed toward the base body 4, and thus facing base body 4.

In this embodiment, the profile cross section (cross section transverse to the longitudinal cross section) of the finger grip 10 is formed by a flat profile which in the longitudinal direction 16 thereof is shaped like a hook. According to the invention, a flat profile is understood to mean a profile which in the profile cross section in particular has a low height compared to its width.

As a result of the configuration of the finger grip 10, the massage apparatus 2 is inserted, in particular leading with its end which is distal with respect to the finger grip 10, into the affected cavity or the affected opening of the human body. The insertion direction of the massage apparatus 2 results, in a self-evident manner, from the configuration of the finger grip 10 on the massage apparatus 2, as will be readily understood.

FIG. 1b shows the massage apparatus 2 according to the invention corresponding to FIG. 1a in the top view as viewed in the direction of arrow A in FIG. 1a, in the same manner of illustration as in FIG. 1a.

For better understanding, the description of the individual figures below is limited in particular to the differences from the first embodiment of a massage apparatus 2 according to the invention.

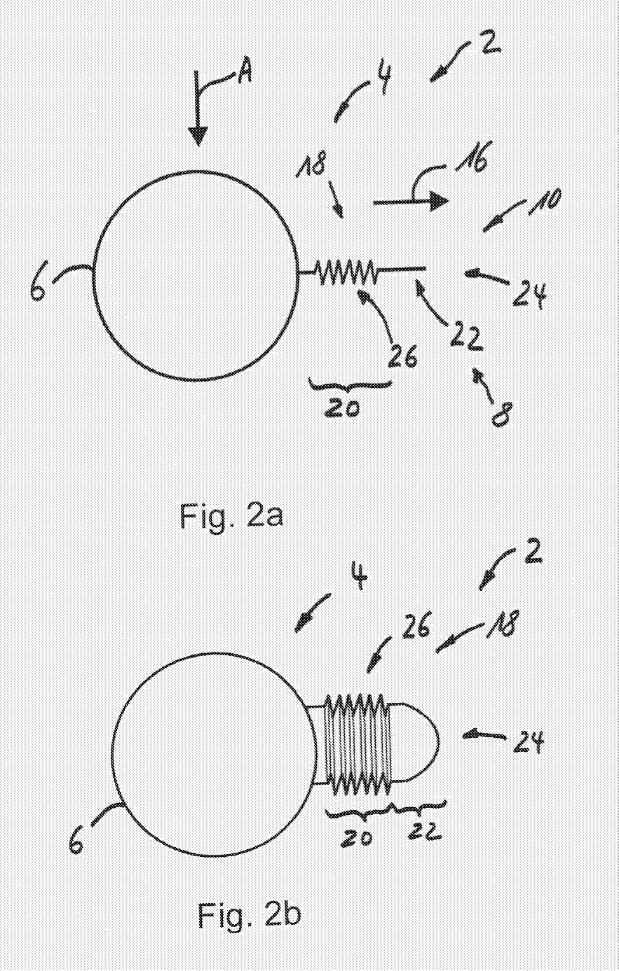

FIG. 2a shows a second embodiment of a massage apparatus 2 according to the invention in a schematic side view. The finger grip 10 has a spring section 18, which in turn has an elongation region 20 in which its shape elasticity is greater than its material elasticity. In addition, this embodiment has a grip section 22 which forms the free end 24 of the finger grip 10.

In this embodiment, the elongation region 20 in the spring section 18 is provided in the manner of a layered fold 26 of the finger grip 10 in a longitudinal direction 16.

FIG. 2b shows this massage apparatus 2 according to the invention corresponding to FIG. 2a in the top view as viewed in the direction of arrow A in FIG. 2a, in the same manner of illustration as in FIG. 2a.

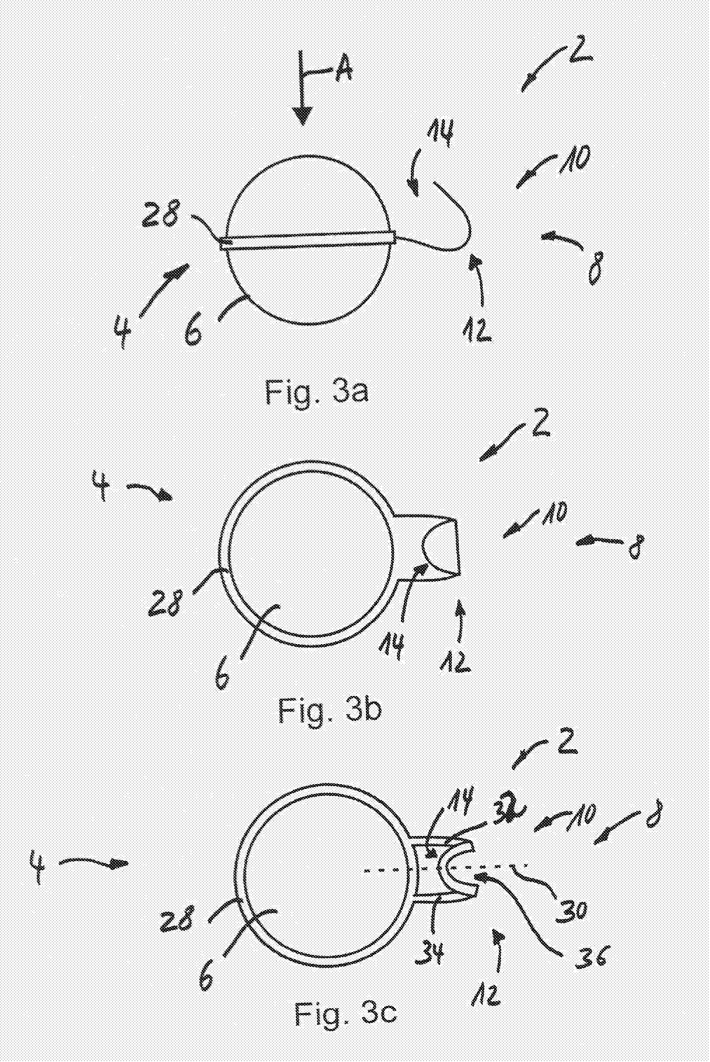

FIG. 3a shows a third embodiment of a massage apparatus 2 according to the invention in a schematic side view. In contrast to the embodiment shown in FIG. 1, in this embodiment of a massage apparatus 2 according to the invention the base body 4 has a holding element 28 on which the massage element 6 is held. For this purpose, the holding element 28 is configured in such a way that it surrounds and correspondingly borders the massage element 6 in a ring-like manner in the peripheral direction of the massage element 6. An adhesive, not illustrated for clarity, is used to intensify the holding action between the holding element 28 and the massage element 6.

In addition, the finger grip 10 is mounted on the holding element 28 in such a way that it is molded onto the holding element 28 in one piece.

FIG. 3b shows the massage apparatus 2 according to the invention corresponding to FIG. 3a in the top view as seen in the direction of arrow A in FIG. 3a, in the same manner of illustration as in FIG. 3a.

In addition, FIG. 3c shows a modification of the third embodiment of a massage apparatus 2 according to the invention corresponding to FIG. 3a as a fourth embodiment of a massage apparatus 2 according to the invention in the top view as seen in the direction f arrow A in FIG. 3a, in a schematic manner of illustration. In contrast to the embodiment shown in FIG. 3a and

FIG. 3b, the finger grip 10 has a recess which extends from the geometric longitudinal center 30 of the finger grip 10 to the end regions 32, 34 thereof. This results in an opening 36 in the finger grip 10 in which, for example, an index finger of the human hand may engage to apply a tensile force.

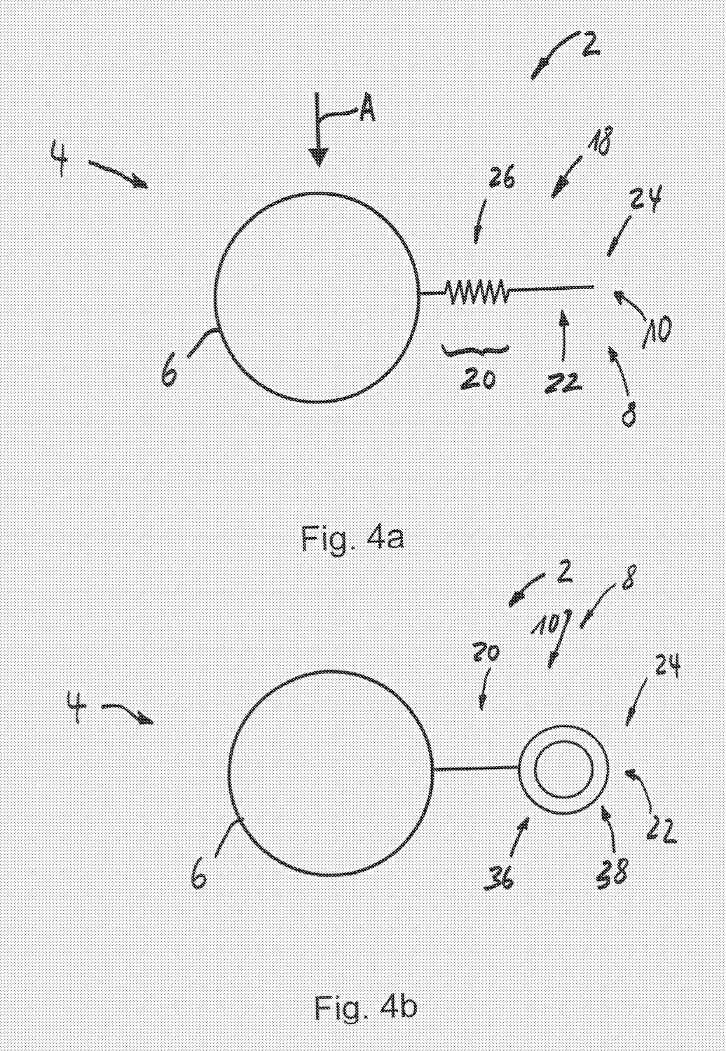

FIG. 4a shows a fifth embodiment of a massage apparatus 2 according to the invention in a schematic side illustration. In contrast to the second embodiment, the grip section 22 has an eyelet-like shape, at least in places, resulting in a grip eyelet 38 in which, for example, the above-mentioned index finger may engage.

FIG. 4b shows the massage apparatus 2 according to the invention corresponding to FIG. 4a in the top view denoted by reference character A in FIG. 4a, in the same manner of illustration as in FIG. 4a.

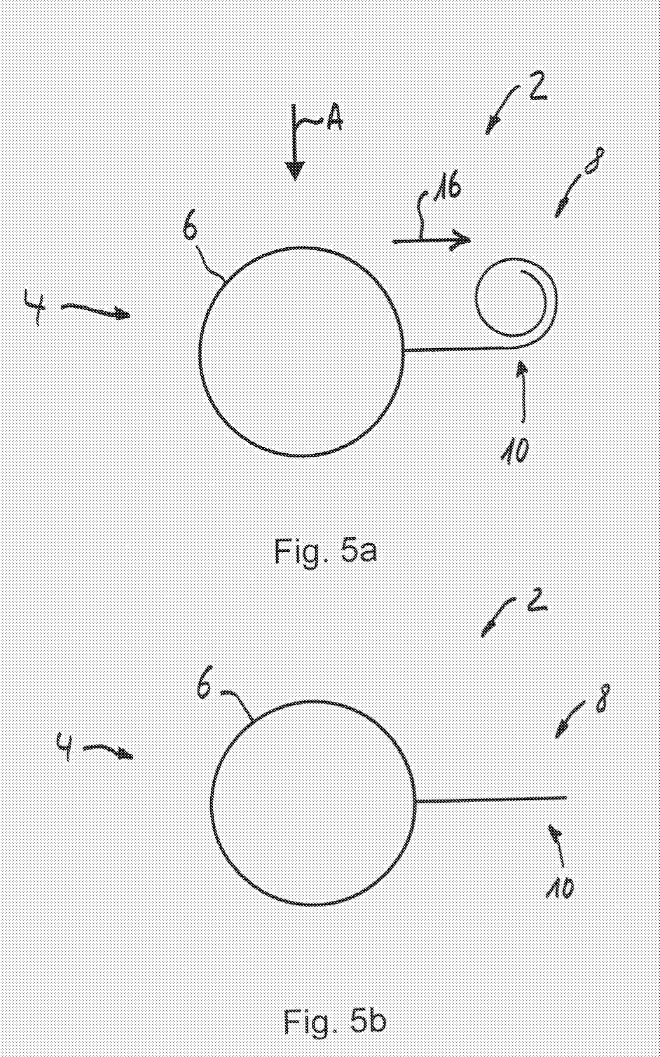

FIG. 5a shows a sixth embodiment of a massage apparatus 2 according to the invention in a schematic side illustration, in which the finger grip 10, in places, is rolled up in a spiral shape in the longitudinal direction 16 with respect to the massage element 6.

FIG. 5b shows the massage apparatus 2 according to the invention corresponding to FIG. 5a in the top view as seen in the direction of arrow A in FIG. 5a, in the same manner of illustration as in FIG. 5a.

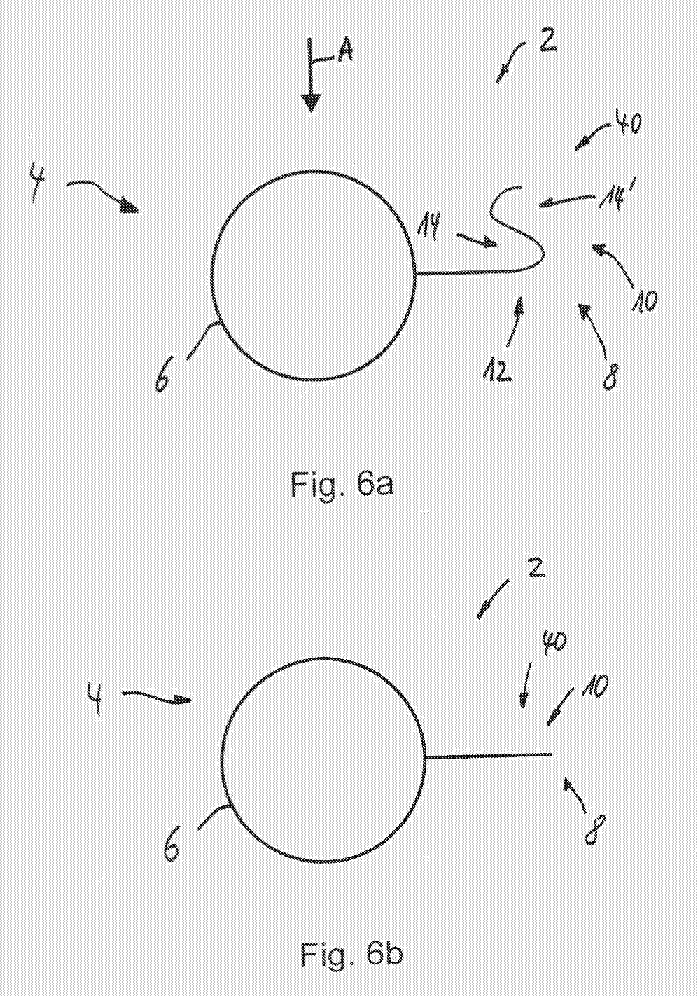

FIG. 6a shows a seventh embodiment of a massage apparatus 2 according to the invention in a schematic side illustration. In contrast to the third embodiment, the S-shaped hook 40 shown is formed by a circular, not a flat, profile, so that in the top view shown in FIG. 6b (according to the view as seen in the direction of arrow A in FIG. 6a) the circular profile is illustrated with a line shape.

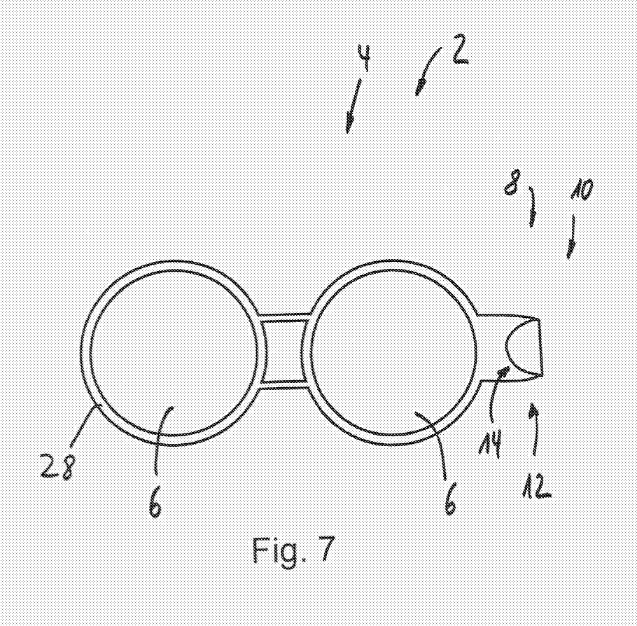

The S-shaped formed hook 40 has two hook openings 14, 14′, the hook opening 14 being directed toward the base body 4 while the hook opening 14′ is directed away from the base body. FIG. 7 shows an eighth embodiment of a massage apparatus 2 according to the invention in a schematic top view (analogous to the view as seen in the direction of arrow A in FIG. 3a). In contrast to the third or fourth embodiment, two identically shaped massage elements 6, 6′ have been used which are spaced apart at a distance with the aid of the holding element 28.

The invention is not limited to the use of identically shaped massage elements 6, 6′. In particular, more than two massage elements 6, 6′ may be used, which may have different sizes and differently shaped outer contours. In addition, the massage elements 6, 6′ may be situated in abutment with one another.

The finger grip 10 may also be configured, among other ways, according to the fourth embodiment of a massage apparatus 2 according to the invention shown in FIG. 3c.

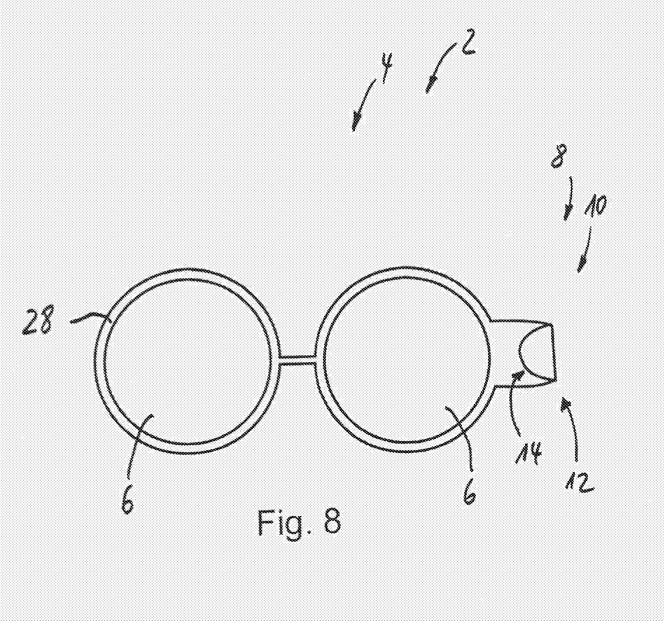

FIG. 8 shows a ninth embodiment of a massage apparatus 2 according to the invention, in a side illustration analogous to FIG. 7. The holding element 28 has a different shape compared to the eighth embodiment shown in FIG. 7.

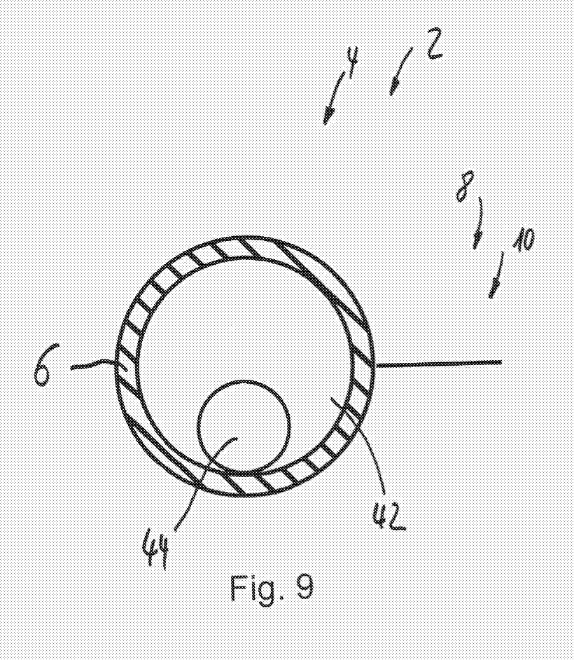

FIG. 9 shows a schematic side illustration of a tenth embodiment of a massage apparatus 2 according to the invention. In contrast to the above-mentioned embodiments, the massage element 6 has a hollow configuration, so that an additional element 44 is accommodated in the cavity 42 that is formed, and which is used in particular to assist the massage function of the massage element 6. For this purpose, the additional element 44 may be situated so as to be freely movable in the cavity. There are also other options for holding or supporting the additional element 44 in the cavity 42 in order to likewise set the additional element in motion when the massage element 6 moves, and optionally, to have the additional element cooperate with the wall of the cavity 42 in the massage element 6.

As previously stated, the invention is not limited to the embodiments of a massage apparatus according to the invention that are shown, and therefore massage apparatuses may be formed in various ways. It is also possible for a massage apparatus according to the invention to have a power source and an appropriate power converter, for example, in order to produce a function or assist a function of the massage apparatus according to the invention. The energy store may be configured as an accumulator which is removable from the massage apparatus. Massage apparatuses according to the invention are configured in particular in such a way that their configuration serves to meet the function. Massage apparatuses which are appropriately configured according to the invention dispense with additional power sources.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention.

1. Massage apparatus for use in a vaginal or rectal cavity or a vaginal or rectal opening of the human body, comprising:
a) base body;
b) the base body including at least one massage element provided on the base body;
c) a pulling device fixedly attached to the base body for removing the massage element from the cavity or opening;
d) the pulling device including a finger grip, the finger grip being partially elastically formed;
e) the finger grip at least partially including an elastic material elastically deformable between a neutral position and a removal position;
f) the finger grip including at least one spring section; and
g) the spring section including an elongation region having a shape elasticity which is greater than its material elasticity.

2. Massage apparatus according to claim 1, wherein:
a) the finger grip has at least one grip section.

3. Massage apparatus according to claim 2, wherein:
a) the grip section has in part an eyelet-like shape.

4. Massage apparatus according to claim 2, wherein:
a) the grip section overlaps the finger section, at least in part.

5. Massage apparatus according to claim 1, wherein:
a) in cross section the finger grip is shaped like a hook at least in part, and at least one hook opening is directed toward the base body.

6. Massage apparatus according to claim 1, wherein:
a) the base body includes at least one holding element by which the working body is held.

7. Massage apparatus according to claim 6, wherein:
a) the at least one holding element at least partially surrounds the working body in a peripheral direction of the working body.

8. Massage apparatus according to claim 6, wherein:
a) the finger grip is mounted on the at least one holding element.

9. Massage apparatus according to claim 1, wherein:
a) the base body is integrally formed.

10. Massage apparatus according to claim 1, wherein:
a) the base body includes a coating, at least in part.

11. Massage apparatus according to claim 7, wherein:
a) the at least one holding element surrounds the working body in a ring-like manner.

12. Massage apparatus according to claim 8, wherein:
a) the finger grip is mounted on the at least one holding element by molding.

13. Massage apparatus according to claim 9, wherein:
a) the base body is integrally formed in one piece.
